(19) United States
(12) Patent Application Publication
(10) Pub. No.: US 2024/0391166 A1
(43) Pub. Date: Nov. 28, 2024

(54) TOOL HEAD FOR THREE-DIMENSIONAL MOLDING AND THREE-DIMENSIONAL MOLDING DEVICE USING THE SAME

(71) Applicant: GUTENBERG CO., LTD., Tokyo (JP)

(72) Inventors: Yuji Yamaguchi, Tokyo (JP); Tetsuya Saito, Tokyo (JP); Tu Minh Nguyen, Tokyo (JP)

(73) Assignee: GUTENBERG CO., LTD., Tokyo (JP)

(21) Appl. No.: 18/672,536

(22) Filed: May 23, 2024

(30) Foreign Application Priority Data
May 24, 2023 (JP) 2023-085128

(51) Int. Cl. B29C 64/209; B29C 64/236; B33Y 30/00

(52) U.S. Cl. CPC B29C 64/209; B29C 64/236; B33Y 30/00

(57) ABSTRACT

The present invention provides a tool head for three-dimensional molding capable of high-speed forming as relating to three-dimensional molding for a fused deposition method that feeds filament in a direct method. The present invention relates to a tool head for a three-dimensional molding device, provided with an extruder for feeding a filament, an extruder motor for driving the extruder, a heating unit for melting the filament fed from the extruder, a nozzle for discharging the filament melted by the heating unit, and a fan for cooling the extruder motor.

### TECHNICAL FIELD

The present invention relates to a tool head for three-dimensional molding and a three-dimensional molding device using the same.

### BACKGROUND ART

In recent years, three-dimensional molding devices that can easily form three-dimensional modeled objects, so-called 3D printers, have become more widespread. There are various types of three-dimensional molding devices; for example, a fused deposition method in which a three-dimensional modeled object is molded by melting filaments of thermoplastic resin such as ABS resin at high temperatures and laminating them is known, inter alia.

In a three-dimensional molding device for fused deposition method, there are two known methods for feeding a filament to a tool head that discharges resin: the so-called Bowden method and the direct method. The Bowden method is a method in which an extruder that feeds a filament to a tool head is attached at a location other than the tool head, such as a frame of the printer, and the direct method is a method in which the extruder is attached to the tool head.

In the Bowden method, since the tool head does not have an extruder, it is easy to reduce the weight of the tool head, which facilitates high-speed forming, but it becomes difficult to feed soft filament material or feed filament material with high precision. Conversely, in the direct method, the tool head is heavier, making it difficult to drive the tool head at high speeds, but this allows the use of a variety of filament materials and also facilitates feeding the filament with high precision.

For example, Patent Document 1 discloses a three-dimensional molding device using a direct type fused deposition method.

### PRIOR ART DOCUMENTS

### Patent Documents

[Patent Document 1] Japanese Patent Application Publication No. 2018-051998

### SUMMARY OF THE INVENTION

### Problem to be Solved by the Invention

An object of the present invention is to provide a tool head for three-dimensional molding and a three-dimensional molding device including the same that can perform high-speed forming as relating to three-dimensional molding for a fused deposition method that feeds filament in a direct method.

### Means to Solve the Problem

The present inventors have discovered that the above-mentioned problems can be solved by the present invention relating to a tool head for a three-dimensional molding device, provided with:
an extruder for feeding a filament;
an extruder motor for driving the extruder;
a heating unit for melting the filament fed from the extruder;
a nozzle for discharging the filament melted by the heating unit; and
a fan for cooling the extruder motor.

### Effect of the Invention

According to the present invention, as relating to three-dimensional molding for a fused deposition method that feeds filament in a direct method, it is possible to provide a tool head for three-dimensional molding and a three-dimensional molding device including the same that can perform high-speed forming.

### BRIEF DESCRIPTION OF DRAWINGS

FIG. 1 shows a cross-sectional view of the tool head according to one embodiment.

FIG. 2 shows a perspective view of the tool head according to one embodiment.

FIG. 3 shows an extruder gear mechanism in the tool head according to one embodiment.

FIG. 4 shows a side view of a hot end portion of the tool head according to one embodiment.

FIG. 5 shows the XY mechanism of the three-dimensional molding device according to one embodiment.

FIG. 6 shows the X bar and pulley attached to the Y bar, which is a linear guide, in the XY mechanism of the three-dimensional molding device according to one embodiment.

FIG. 7 shows a state in which the motor is spatially isolated from the chamber in which molding is performed in the XY mechanism of the three-dimensional molding device according to one embodiment.

FIG. 8 shows a state in which the motor of the XY mechanism is exposed to the outside in the three-dimensional molding device according to one embodiment.

### EMBODIMENTS OF INVENTION

The present invention will be specifically described using the following embodiments as examples, but the present invention is not limited thereto. When there is no particular detailed mention of each device, mechanism, means, and the like in the present Specification, a person skilled in the art can use well-known mechanical devices, mechanisms, means, and the like for these. Each embodiment can be combined by a person skilled in the art based on common knowledge, and configurations not specified for each embodiment have the same configuration as other embodiments or a configuration suitable for that embodiment.

In the present Specification, the “horizontal direction” refers to an X-Y direction in the drawing, and “horizontal” refers to one or both of an X-Z direction and a Y-Z direction of an X-Y plane and means that the displacement in the Z direction is negligible in three-dimensional modeling. Furthermore, the “vertical direction” refers to the Z direction in the drawings.

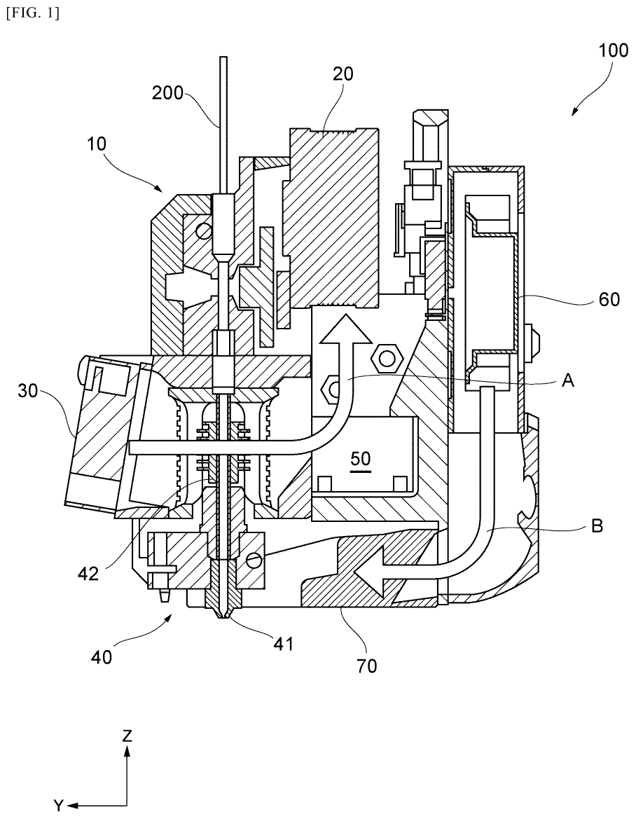

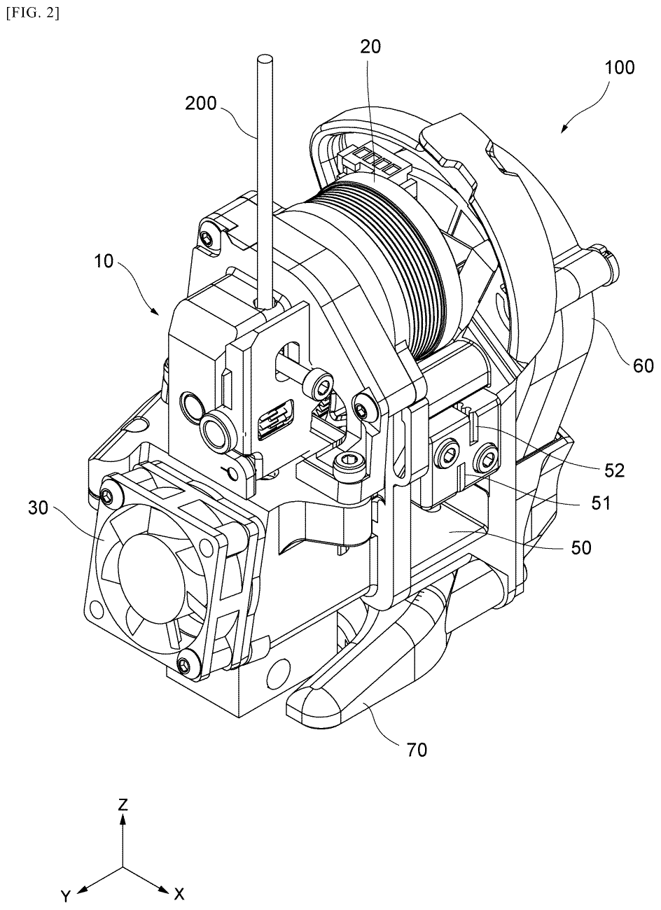

FIG. 1 shows a cross-sectional view of a tool head according to one embodiment, and FIG. 2 shows a perspective view thereof.

A tool head 100 includes an extruder 10 for feeding a filament 200, an extruder motor 20 for driving the extruder 10, a heating unit 40 for melting the filament 200 fed from the extruder 10, a nozzle 41 for discharging the filament 200 melted by the heating unit 40, and a fan 30 for cooling the extruder motor 20.

The extruder 10 is a mechanism for feeding the filament 200 provided from outside the tool head 100 to the heating unit 40 for melting the filament and the nozzle 41 beyond that. The extruder 10 is driven by the extruder motor 20.

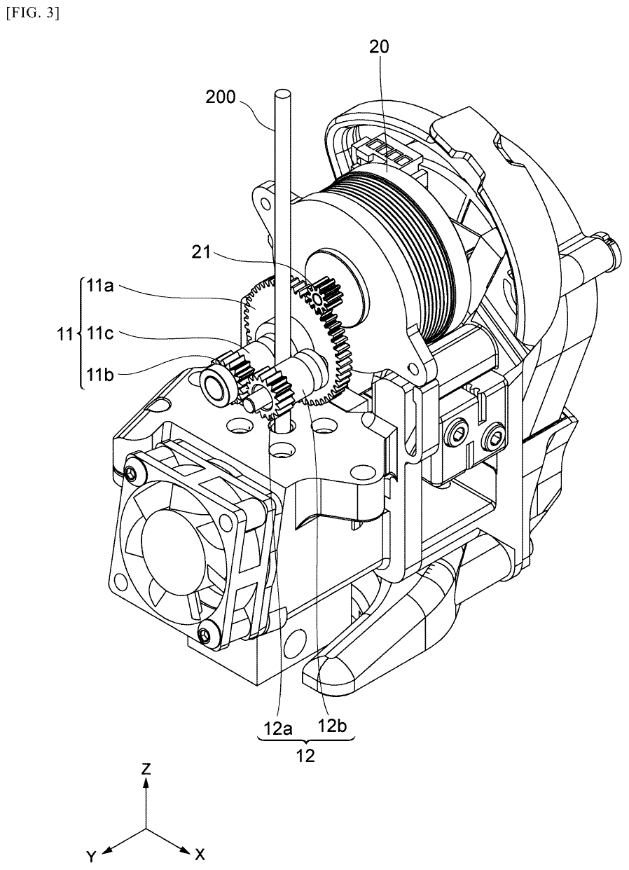

As shown in FIG. 3, the extruder 10 includes a first rotating member 11 and a second rotating member 12. The first rotating member 11 includes a first driven gear 11a driven by a first driving gear 21 of the extruder motor 20, a second driving gear 11b that transmits driving force to the second rotating member 12, and a first support shaft 11c that supports the first driven gear 11a and the second driving gear 11b. Furthermore, the second rotating member 12 has a second driven gear 12a that receives driving force from the second driving gear 11b, and a second support shaft 12b that supports the second driven gear 12a.

The first driving gear 21 of the extruder motor 20 has a relatively small diameter and a relatively small number of teeth, and due to the extruder motor 20 rotating at a high rotational speed, the first driven gear 11a of the first rotating member 11 can be driven with a small torque. The first driven gear 11a has a relatively large diameter and a relatively large number of teeth and can obtain high torque at a small rotational speed.

The first support shaft 11c is rotatably attached to an exterior or the like within the tool head and rotates due to the rotation of the first driven gear 11a, whereby the second driving gear 11b also rotates. The second driving gear 11b drives the second rotating member 12. The second driving gear 11b has a smaller diameter and fewer teeth than the first driven gear 11a.

The second support shaft 12b is also rotatably attached to an exterior or the like within the tool head and rotates due to the rotation of the second driven gear 12a driven by the second driving gear 11b. The second driving gear 11b and the second driven gear 12a have substantially the same diameter and the same number of teeth.

The filament 200 is fed while sandwiched between the first support shaft 11c and the second support shaft 12b, but is not limited thereto and may be fed using one of the first rotating member 11 and the second rotating member 12, for example, other members attached to the first support shaft 11c and the second support shaft 12b.

Examples of the material of the filament 200, include polyolefin resin, styrene resin, vinyl chloride resin, urethane resin, polyester resin, polyamide resin, polylactic acid resin, and the like.

The extruder motor 20 drives the extruder 10. In this embodiment, the extruder 10 is located at the top of the tool head 100 to draw in the filament 200, and the extruder motor 20 for driving such is also located at the top of the tool head 100.

The extruder motor 20 is cooled by the fan 30. In this embodiment, the fan 30 is a hot end fan 30 for cooling the heating unit 40 for melting the filament 200. Cooling air A from the hot end fan 30 is configured to reach the extruder motor 20 after cooling the heating unit 40, and a ventilation passage for the cooling air A to pass through is present inside the tool head 100. The heating unit 40 is located at the bottom of the extruder 10, and thus the cooling air A is configured to flow from the bottom to the top within the tool head 100.

The fan 30 is not limited to a hot end fan and may be an independent fan for cooling the extruder motor 20 or may be configured such that a parts cooling fan 60 also cools the extruder motor 20.

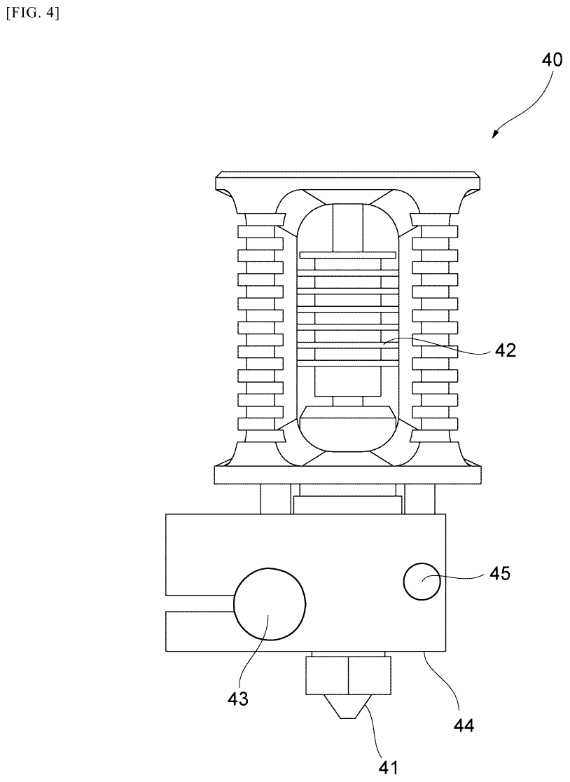

The heating unit 40 is also called a hot end and may have a heater 43 for melting the filament and a heat sink 44 for preventing the filament from melting in the filament flow path. For example, as shown in FIG. 4, the heating unit 40 can include a nozzle 41 that discharges a molten filament, a heat sink 42 that is cooled by cooling air A, a heater 43 that is a heat generating unit, a heat block 44 that retains heat, and a thermistor 45 for measuring temperature. The filament melted by the heater 43 and the heat block 44 is cooled by the cooling air A in the vicinity of the heat sink 42, and thus melting in that vicinity can be prevented. Thus, the filament 200 from the extruder 10 can be reliably fed to the heater 43 at the bottom of the tool head 100.

In this embodiment, the tool head 100 is slidably attached to an X bar of an XY mechanism for moving the tool head 100 in the horizontal direction. The tool head 100 has a mounting unit 50 for mounting the X bar, and by configuring the X bar from, for example, a linear guide, the mounting unit 50 of the tool head 100 is fixed to a block of the linear guide. Furthermore, when the tool head 100 is moved in the horizontal direction by the XY mechanism that uses two belts, as shown in FIG. 2, belt connection units 51 and 52 for this purpose can be provided.

In this embodiment, the tool head 100 has the parts cooling fan 60, which can effectively cool the resin discharged from the nozzle 41, and thus it is possible to perform molding without causing unevenness and the like on the surface of a modeled object. The position of the parts cooling fan 60 is not particularly limited, but in this embodiment, it is located on the back side of the tool head 100 and the air sucked in from the back side is passed through a fan duct 70, and a cooling air B is sent to the modeled object.

The tool head 100 further includes various members such as a cable for sending signals to the tool head 100 and a sensor for measuring a distance to the build plate, but these are not related to the features of the present invention and thus are omitted in the drawings.

For example, the tool head 100 may include a touch-type leveling sensor known in the present field as a levelness measuring mechanism. Levelness of the build plate can be measured by using the tool head 100 to scan above the build plate and measuring the distance from the modeling head in the Z direction at, for example, three positions. As the levelness measuring mechanism, various forms such as an electromagnetic induction sensor, a Tof optical sensor, a LiDAR sensor, or an energized sensor can be used.

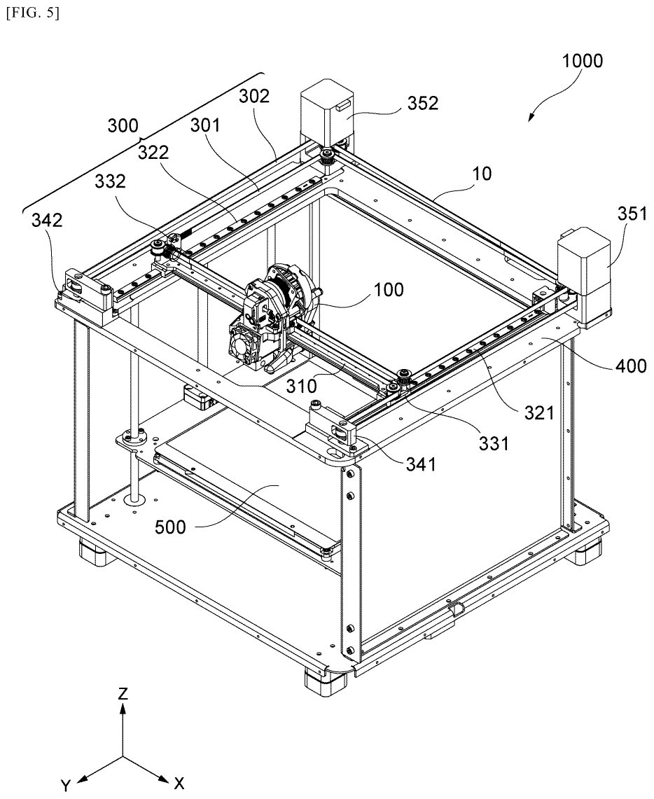

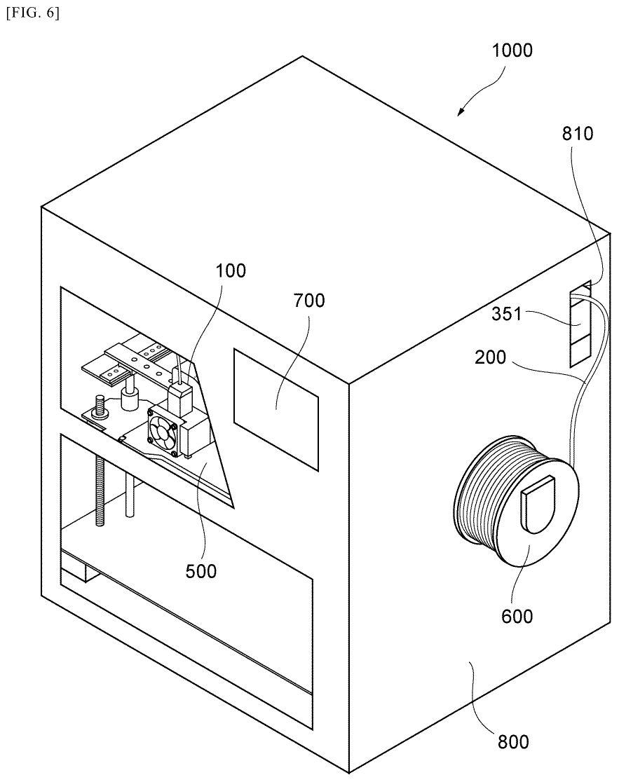

FIG. 5 shows a portion of a three-dimensional molding device 1000, and the three-dimensional molding device 1000 includes a tool head 100, an XY mechanism 300, an XY plate 400 to which the XY mechanism 300 is attached, and a build plate 500, which are illustrated, and the filament, the housing, the lifting mechanism, the control device, the power source, and the like are not illustrated. FIG. 6 shows a three-dimensional molding device 1000 including a filament 200, a filament roll 600, a control device 700, and a housing 800.

The three-dimensional molding device 1000 is a fused deposition type device. In this method, a modeled object is formed on the build plate 500 while the filament 200 of thermoplastic resin, which is a modeling material, is melted by the tool head 100. The tool head 100 moves in the horizontal direction and discharges molten resin onto the build plate 500, while the build plate 500 is moved in the vertical direction by a lifting mechanism to form a three-dimensional modeled object. The thermoplastic filament 200 is supplied from the filament roll 600 outside the housing 800 to the extruder 10 of the tool head 100 through an opening 810 in the housing 800. The filament 200 is supplied to the tool head 100 by such a modeling material supply mechanism.

The tool head 100 can move in the horizontal direction, and an open source operation system called the CoreXY system can be adopted as a method for this movement. However, the XY mechanism is not limited thereto, insofar as the tool head 100 can be moved in the horizontal direction, and other systems such as the Descartes (Cartesian) system, cross gantry system, H-bot system, and the like may also be used.

FIG. 5 shows an embodiment in which the XY mechanism is a CoreXY system. In this method, two belts 301 and 302 are connected to the tool head 100, and the tool head 100 is driven in the X-Y plane. By moving the two belts 301 and 302 with two motors 351 and 352, the tool head 100 can be freely moved through an X bar 310 and two Y bars 321 and 322.

In this XY mechanism, it is extremely important to equalize the tension of the two belts 301 and 302, and this XY mechanism further includes belt tensioners 341 and 342 respectively corresponding to the two belts 301 and 302. Furthermore, this XY mechanism has pulleys 331 and 332 that change the belt in the Y direction on the Y bar to the X direction on the X bar, and there are also other pulleys at various locations.

In this embodiment, the two Y bars 321 and 322 are fixed on the XY plate 400 to reduce the influence of vibration. One X bar 310 is connected to the tool head 100 and is attached across the two Y bars 321 and 322 at both ends of the X bar 310.

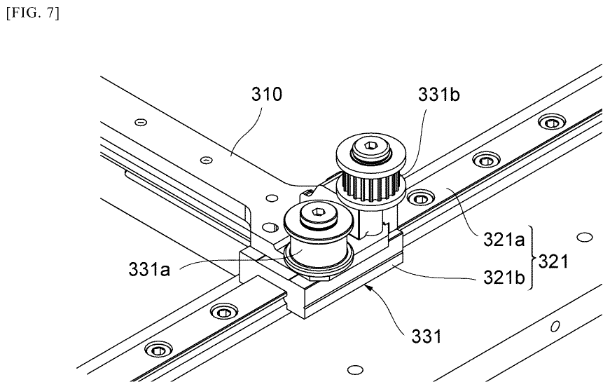

As shown in FIG. 7, the Y bar 321 can be configured from a linear guide having a rail 321a and a block 321b, and the X bar 310 can be fixedly attached to the block 321b of the Y bar 321. Pulleys 331a and 331b for two more belts (omitted from the drawing) are attached to the block 321b of the Y bar 321. In such an embodiment, the XY mechanism can be constructed in a very simple and lightweight manner, thereby making it possible to horizontally move the tool head 100 at high speed.

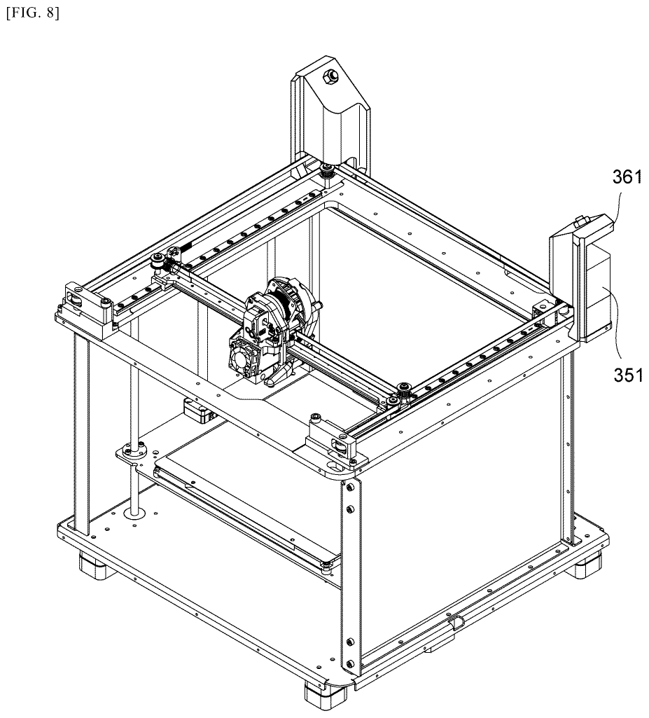

As shown in FIG. 8, the motor 351 for the XY mechanism may be covered by a motor cover 361 in a manner that does not interfere with the driving of the belts 301 and 302. Thereby, the motor 351 can be spatially isolated from the chamber in which three-dimensional molding is performed. In such an embodiment, due to the motor being outside the chamber, which is hot inside, it is possible prevent the motor of the XY mechanism from overheating. Thus, it becomes possible to operate the motor with a large load, and it becomes possible to horizontally move the tool head at high speed. Furthermore, even when the temperature inside the chamber is relatively high, the motor of the XY mechanism is unlikely to be adversely affected, so such a configuration is also advantageous when using a filament that is melted at a relatively high temperature.

In this embodiment, the motor 351 is spatially isolated from the inside of the chamber by the motor cover 361, and is exposed to outside air through an opening in the housing 800, as shown in FIG. 7. Thereby, the motor 351 can be cooled by the outside air. However, the motor 351 needs not be limited to such a location to obtain the above advantageous effects, insofar as it is spatially isolated from the inside of the chamber.

The build plate 500 can be moved in the vertical direction by the lifting mechanism, thereby allowing layers of the modeling material discharged from the tool head 100 to be stacked. The lifting mechanism can be configured from a motor, a sliding screw, and the like.

Various setup is performed for the three-dimensional molding device 100 by using a control panel of the control device 700, or through a terminal connected to the control device 60 by wire or wirelessly. Although not illustrated, a circuit board of the control device 700 can be located at a bottom, rear surface portion, or the like of the three-dimensional molding device 100. The control device 700 can control operation of the tool head 100, the XY mechanism 300, the build plate 500, and the like by controlling a motor and the like, and can control the temperature of the tool head 100, the build plate 500, and the like by controlling a heater, a fan, and the like.

The first embodiment relates to a tool head for a three-dimensional molding device, provided with:
an extruder for feeding a filament;
an extruder motor for driving the extruder;
a heating unit for melting the filament fed from the extruder;
a nozzle for discharging the filament melted by the heating unit; and
a fan for cooling the extruder motor.

The embodiment is characterized in that the extruder motor is cooled by a fan. Thereby, even when the extruder motor is driven with a large current under a high load, the influence of overheating can be prevented. That is, in the tool head of the embodiment, instead of using a normal motor to perform normal driving, a relatively small and lightweight motor is used to drive with a large load. By using a relatively small and lightweight motor, as the extruder motor, which occupies a particularly large volume and weight among the parts of the tool head, the entire tool head can be made smaller, and the weight of the tool head can be reduced, whereby it is possible to reduce the size of the chamber and improve the speed and acceleration of the head, enabling high-speed forming. Reducing the size of the chamber in which modeling is performed can lead to downsizing of the entire device and improvement of thermal efficiency, and thus such a configuration is extremely advantageous. Furthermore, even when the extruder motor reaches a relatively high temperature, cooling with a fan makes adverse effects more unlikely, and thus such a configuration is also advantageous when using a filament that is melted at a relatively high temperature.

As a second embodiment, in the tool head, the fan for cooling the extruder motor is a hot end fan that cools the heating unit and is configured such that cooling air from the hot end fan cools the extruder motor together with the heating unit.

Such an embodiment is extremely advantageous because it enables cooling of the extruder motor without the need for a separate fan for the extruder motor. Additionally, having the hot end fan can prevent the filament from melting within the filament flow path and making feeding difficult.

As a third embodiment, a ventilation passage for the cooling air is present in the tool head.

In such an embodiment, cooling air from the hot end fan can effectively reach on the extruder motor, effectively cooling the hot end fan.

As a fourth embodiment, the extruder has a first rotating member and a second rotating member in the tool head, wherein:
the first rotating member is provided with
a first driven gear receiving driving force from a first driving gear of the extruder motor,
a second driving gear that transmits driving force to the second rotating member, and
a first support shaft that supports the first driven gear and the second driving gear; the second rotating member is provided with
a second driven gear receiving driving force from the second driving gear, and
a second support shaft that supports the second driven gear; and
the filament is fed while sandwiched between the first rotating member and the second rotating member.

In such an embodiment, by varying the number of teeth on the driving gear and driven gear, the torque and speed at which the extruder motor feeds the filament can be freely selected.

As a fifth embodiment, in the tool head, the first driven gear has more teeth than the first driving gear, and the second driving gear has fewer teeth than the first driven gear.

In such an embodiment, the first driven gear has more teeth than the first driving gear, and the second driving gear has fewer teeth than the first driven gear, thereby even when the torque of the extruder motor is relatively small, the filament can be fed by rotating the first rotating member and the second rotating member. As a result, a small, low-torque motor can be used as the extruder motor, so the weight of the tool head can be reduced, thereby enabling high-speed forming. Furthermore, the speed is reduced by gears, which increases the resolution of feeding and facilitates more precise feeding.

As a sixth embodiment, the tool head is further comprising a parts cooling fan for cooling a modeled object.

In such an embodiment, the resin discharged from the nozzle can be effectively cooled, and thus the modeled object can be molded without causing unevenness or the like on the surface.

As a seventh embodiment, the three-dimensional molding device is provided with:
the tool head as described above;
an XY mechanism that moves the tool head in the horizontal direction;
a build plate on which a modeled object discharged from the tool head is placed;
a lifting mechanism that lifts and lowers the build plate;
a filament providing mechanism that provides filament to the tool head; and
a control device that controls these operations.

According to the three-dimensional molding device of this embodiment, the tool head can be made smaller and lighter, enabling high-speed forming.

As an eighth embodiment, in the three-dimensional molding device, the XY mechanism is provided with
two belts that horizontally move the tool head,
two motors driving each of the belts, and
an X bar connected to the tool head, and two Y bars on both sides of the X bar; and
the two Y bars are composed of a linear guide having a rail and a block, and pulleys for the two belts are present on the block.

In such an embodiment, the XY mechanism can be configured very simply and at a light weight without employing a carriage that is normally used for two Y bars, thereby allowing the tool head to move horizontally at high speed.

As a ninth embodiment, in the three-dimensional molding device, the two motors of the XY mechanism are located outside a chamber in which three-dimensional molding is performed.

In such an embodiment, the motors being present outside the chamber, which is hot inside, can prevent the two motors of the XY mechanism from overheating. Thereby, it is possible to operate with a large load on the motor and to horizontally move the tool head at high speed.

### DESCRIPTION OF REFERENCE NUMERALS

10 . . . Extruder
11 . . . First rotating member
11a . . . First driven gear
11b . . . Second driving gear
11c . . . First support shaft
12 . . . Second rotating member
12a . . . Second driven gear
12b . . . Second support shaft
20 . . . Extruder motor
21 . . . First driving gear
30 . . . Fan (hot end fan)
40 . . . Heating unit
41 . . . Nozzle
42 . . . Heat sink
43 . . . Heater
44 . . . Heat block
45 . . . Thermistor
50 . . . Mounting unit
51, 52 . . . Belt connection unit
60 . . . Parts cooling fan
70 . . . Duct
100 . . . Tool head
200 . . . Filament
300 . . . XY mechanism
301, 302 . . . Belt
310 . . . X bar
321, 322 . . . Y bar
321a . . . Rail
321b . . . Block
331, 332, 331a, 331b . . . Pulley
341, 342 . . . Belt tensioner
351, 352 . . . Motor
361 . . . Motor cover
400 . . . XY plate
500 . . . Build plate
600 . . . Filament roll
700 . . . Control device
800 . . . Housing
810 . . . Opening
1000 . . . Three-dimensional molding device

1. A tool head for a three-dimensional molding device, comprising:
an extruder for feeding a filament;
an extruder motor for driving the extruder;
a heating unit for melting the filament fed from the extruder;
a nozzle for discharging the filament melted by the heating unit; and
a fan for cooling the extruder motor.

2. The tool head according to claim 1, wherein the fan for cooling the extruder motor is a hot end fan that cools the heating unit and is configured such that cooling air from the hot end fan cools the extruder motor together with the heating unit.

3. The tool head according to claim 2, wherein a ventilation passage for the cooling air is present therein.

4. The tool head according to claim 1, wherein
the extruder has a first rotating member and a second rotating member;
the first rotating member is provided with:
a first driven gear receiving driving force from a first driving gear of the extruder motor,
a second driving gear that transmits driving force to the second rotating member, and
a first support shaft that supports the first driven gear and the second driving gear;
the second rotating member is provided with:
a second driven gear receiving driving force from the second driving gear, and
a second support shaft that supports the second driven gear; and
the filament is fed while sandwiched between the first rotating member and the second rotating member.

5. The tool head according to claim 4, wherein the first driven gear has more teeth than the first driving gear and the second driving gear has fewer teeth than the first driven gear.

6. The tool head according to claim 1, further comprising a parts cooling fan for cooling a modeled object.

7. A three-dimensional molding device, comprising:
the tool head according to claim 1;
an XY mechanism that moves the tool head in the horizontal direction;
a build plate on which a modeled object discharged from the tool head is placed;
a lifting mechanism that lifts and lowers the build plate;
a filament providing mechanism that provides filament to the tool head; and
a control device that controls these operations.

8. The three-dimensional molding device according to claim 7, wherein the XY mechanism is provided with:
two belts that horizontally move the tool head,
two motors driving each of the belts, and
an X bar connected to the tool head, and two Y bars on both sides of the X bar; and
the two Y bars are composed of a linear guide having a rail and a block, and pulleys for the two belts are present on the block.

9. The three-dimensional molding device according to claim 8, wherein the two motors of the XY mechanism are located outside a chamber in which three-dimensional molding is performed.

10. A three-dimensional molding device, comprising:
the tool head according to claim 2;
an XY mechanism that moves the tool head in the horizontal direction;
a build plate on which a modeled object discharged from the tool head is placed;
a lifting mechanism that lifts and lowers the build plate;
a filament providing mechanism that provides filament to the tool head; and
a control device that controls these operations.

11. A three-dimensional molding device, comprising:
the tool head according to claim 3;
an XY mechanism that moves the tool head in the horizontal direction;
a build plate on which a modeled object discharged from the tool head is placed;
a lifting mechanism that lifts and lowers the build plate;
a filament providing mechanism that provides filament to the tool head; and
a control device that controls these operations.

12. A three-dimensional molding device, comprising:
the tool head according to claim 4;
an XY mechanism that moves the tool head in the horizontal direction;
a build plate on which a modeled object discharged from the tool head is placed;
a lifting mechanism that lifts and lowers the build plate;
a filament providing mechanism that provides filament to the tool head; and
a control device that controls these operations.

13. A three-dimensional molding device, comprising:
the tool head according to claim 5;
an XY mechanism that moves the tool head in the horizontal direction;
a build plate on which a modeled object discharged from the tool head is placed;
a lifting mechanism that lifts and lowers the build plate;
a filament providing mechanism that provides filament to the tool head; and
a control device that controls these operations.

14. A three-dimensional molding device, comprising:
the tool head according to claim 16;
an XY mechanism that moves the tool head in the horizontal direction;
a build plate on which a modeled object discharged from the tool head is placed;
a lifting mechanism that lifts and lowers the build plate;
a filament providing mechanism that provides filament to the tool head; and
a control device that controls these operations.

15. The three-dimensional molding device according to claim 10, wherein the XY mechanism is provided with:
two belts that horizontally move the tool head,
two motors driving each of the belts, and
an X bar connected to the tool head, and two Y bars on both sides of the X bar; and
the two Y bars are composed of a linear guide having a rail and a block, and pulleys for the two belts are present on the block.

16. The three-dimensional molding device according to claim 11, wherein the XY mechanism is provided with:
two belts that horizontally move the tool head,
two motors driving each of the belts, and
an X bar connected to the tool head, and two Y bars on both sides of the X bar; and
the two Y bars are composed of a linear guide having a rail and a block, and pulleys for the two belts are present on the block.

17. The three-dimensional molding device according to claim 12, wherein the XY mechanism is provided with:
two belts that horizontally move the tool head,
two motors driving each of the belts, and
an X bar connected to the tool head, and two Y bars on both sides of the X bar; and
the two Y bars are composed of a linear guide having a rail and a block, and pulleys for the two belts are present on the block.

18. The three-dimensional molding device according to claim 13, wherein the XY mechanism is provided with:
two belts that horizontally move the tool head,
two motors driving each of the belts, and
an X bar connected to the tool head, and two Y bars on both sides of the X bar; and
the two Y bars are composed of a linear guide having a rail and a block, and pulleys for the two belts are present on the block.

19. The three-dimensional molding device according to claim 14, wherein the XY mechanism is provided with:
two belts that horizontally move the tool head,
two motors driving each of the belts, and
an X bar connected to the tool head, and two Y bars on both sides of the X bar; and
the two Y bars are composed of a linear guide having a rail and a block, and pulleys for the two belts are present on the block.

20. The three-dimensional molding device according to claim 15, wherein the XY mechanism is provided with:
two belts that horizontally move the tool head,
two motors driving each of the belts, and
an X bar connected to the tool head, and two Y bars on both sides of the X bar; and
the two Y bars are composed of a linear guide having a rail and a block, and pulleys for the two belts are present on the block.
